(19) United States
(12) Patent Application Publication
(10) Pub. No.: US 2023/0000273 A1
(43) Pub. Date: Jan. 5, 2023

(54) Multifunctional Praying Barrier Device

(71) Applicant: Jatmiko Agus Santosa, Salisbury, MD (US)

(72) Inventor: Jatmiko Agus Santosa, Salisbury, MD (US)

(21) Appl. No.: 17/363,668

(22) Filed: Jun. 30, 2021

(51) Int. Cl. A47G 33/00

(52) U.S. Cl. CPC A47G 33/008

(57) ABSTRACT

A multi-functional prayer barrier is an apparatus intended to provide a barrier to show the praying area of a muslim who has no natural barriers such as walls, pillars, people etc. Its purpose is to prevent somebody from passing the area between a muslim in prayer and the barrier. To accomplish this, the apparatus includes a deployable and collapsible tripod that is axially mounted to an extendable and retractable rod. Further, the device itself is very light, compact, and fits within a wallet. Other than its main purpose as a praying barrier, the apparatus is a multifunctional tool that includes an extendable magnet pickup tool, a ruler, a fire starter, and a magnifying glass, such that, the device will also be beneficial even to non-muslim users. Furthermore, the apparatus supports a removable extra sign to make the barrier more noticeable by other people from a distance.

### FIELD OF THE INVENTION

The present invention relates generally to a praying barrier or sutrah, that provides a barrier and show the praying area of a Muslim who has no natural barrier, such as walls, pillars, people etc. More specifically, the present invention is a multifunctional tool and praying barrier, that is compact, collapsible and fits within a wallet of a user.

### BACKGROUND OF THE INVENTION

A sutrah is an object that is used by a Muslim when performing prayer alone and acts as a barrier between him or her and someone passing in front of them. The important obligatory ritual for all Muslim is the five prayers, that is why the prayers is the pillar of Islam. Traditional sutrah usually includes camel or horse saddle, arrow, chair, wall, tree, pillar etc. However, today these objects are not convenient for travel and not always accessible. Various sutrah have been developed for assisting a Muslim when performing prayer, but they need extra space and effort to carry or to handle. Thus, a multifunctional sutrah, that would be beneficial for Muslims or non-Muslims, and that can fit within a wallet in a pocket, with no need of extra space and effort is a rare find in the current market.

An objective of the present invention is to provide a barrier to show the praying area of a muslim who has no natural barriers such as walls, pillars, people etc. Its purpose is to prevent somebody from passing the area between a Muslim in prayer and the sutrah. To accomplish this, the present invention comprises a deployable and collapsible tripod, as well as an extendable and retractable rod, that are axially mounted to each other. Further, the device itself is very light, compact, and fits within a wallet. Other than its main purpose as a praying barrier, the present invention is a multifunctional tool that includes an extendable magnet pickup tool, a ruler, a fire starter, and a magnifying glass. Thus, the present invention will also be beneficial to even non-muslim users. Furthermore, the present invention supports a removable extra sign to make the barrier more noticeable by other people from a distance. Thus, the present invention is a user friendly and compact device that serves as a praying barrier as well as a multifunctional tool.

### BRIEF DESCRIPTION OF THE DRAWINGS

FIG. 1 is a perspective view of the present invention in deployed mode, wherein a user is shown offering his prayer and using the present invention as a sutrah.

FIG. 2 is a front elevational view of the present invention in a collapsed mode, wherein a ruler is integrated along a vertical edge of the first panel.

FIG. 3 is a front elevational view of the present invention in a collapsed mode, wherein a ruler is integrated along a horizontal edge of the first panel.

FIG. 4 is a right-side elevational view of the present invention.

FIG. 5 is a top plan view of the present invention in the collapsed mode.

FIG. 6 is a top-front-left perspective view of the present invention is deployed mode.

FIG. 7 is a detailed view of the tripod, wherein the magnifying lens is pulled up from the first panel.

FIG. 8 is a rear side elevational view of the present invention, wherein the magnifying lens is pulled up from the first panel.

FIG. 9 is a top view of the present invention in deployed mode.

FIG. 10 is an exploded top-front-left perspective view of the present invention in collapsed mode.

FIG. 11 is a front perspective view, wherein the present invention is placed horizontally within a wallet.

FIG. 12 is a front perspective view, wherein the present invention is placed vertically within a wallet.

### DETAIL DESCRIPTIONS OF THE INVENTION

All illustrations of the drawings are for the purpose of describing selected versions of the present invention and are not intended to limit the scope of the present invention.

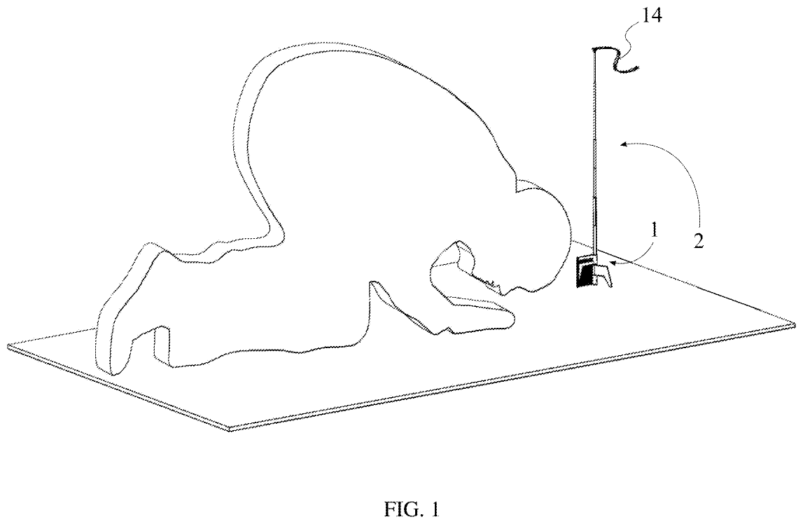

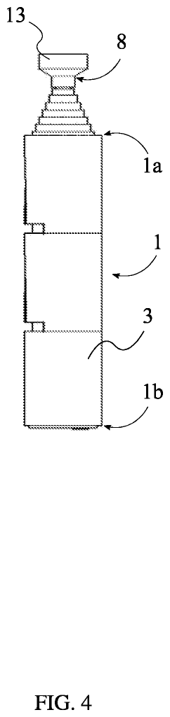

In reference to FIG. 1 through FIG. 12, the present invention is a multifunctional prayer barrier. An objective of the present invention is to provide a barrier to show the praying area of a muslim who has no natural barriers such as walls, pillars, people etc. Its purpose is to prevent somebody from passing the area between a muslim in prayer and the sutrah. To accomplish this, the present invention comprises a deployable and collapsible tripod, as well as an extendable and retractable rod. Further, the device itself is very light, compact, and fits within a wallet. Other than its main purpose as a praying barrier, the present invention is a multifunctional tool that includes an extendable magnetic pickup tool, a ruler, a fire starter, and a magnifying glass, such that, the present invention will also be beneficial to even non-muslim users. Furthermore, the present invention supports a removable extra sign to make the barrier more noticeable by other people from a distance. Thus, the present invention is a user friendly and compact device that serves as a praying barrier as well as a multifunctional tool.

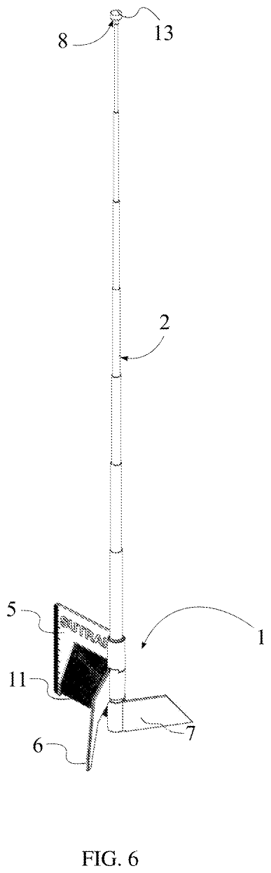

The following description is in reference to FIG. 1 through FIG. 12. According to a preferred embodiment of the present invention, the present invention comprises a tripod 1, and an extendable rod 2. Preferably, the tripod material can be metal or plastic, and the extendable rod 2 comprises metal. As seen in FIG. 1 and FIG. 6, the extendable rod 2 is a telescopic metal tube comprising a plurality of sections of individual telescopic metal tube, which constitutes the main body of the present invention. When extended or deployed, the extendable rod 2 is preferably around 550 mm high. Furthermore, the tripod 1 is a credit card sized device, which when deployed provides the support for the main body of the present invention. However, the tripod 1 and the extendable rod 2 may comprise any other material, size, shape, and deployment technology that are known to one of ordinary skill in the art, as long as the intents of the present invention are not altered.

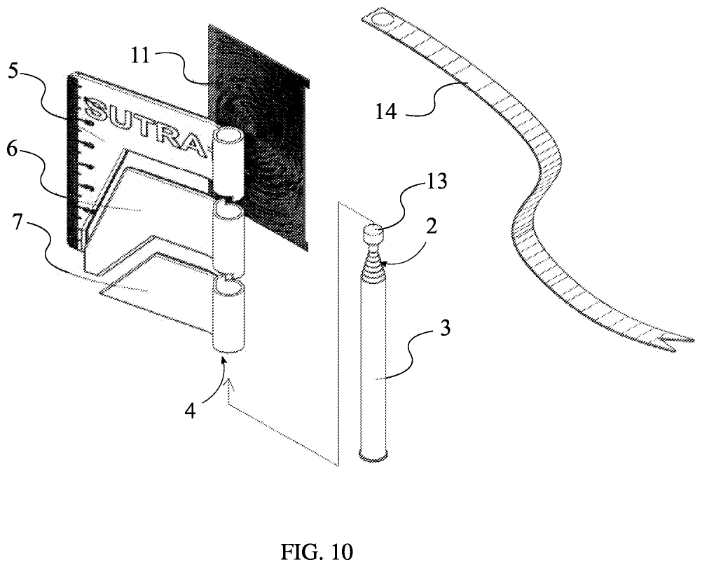

According to the preferred embodiment, the tripod 1 comprises a tripod stand 3, a canal 4, a first panel 5, a second panel 6, and a third panel 7. As seen in FIG. 10, the canal 4 traverses normally and centrally through the tripod stand 3, such that the extendable rod 2 is mounted within the canal 4. In other words, the tripod stand 3 constitutes a vertical support structure, and the canal 4 constitutes the cavity for placing the extendable rod 2. Furthermore, the second panel 6 and the third panel 7 are axially mounted around the extendable rod 2, such that the second panel 6 and third panel 7 may rotate to provide the necessary support for the main body of the device in a deployed state, as well as retract into a compact and planar device in a collapsed state. In other words, the tripod 1 is operatively coupled to the extendable rod 2, wherein manipulating the second panel 6, the third panel 7, and a terminal end 8 of the extendable rod 2, enables switching the device between a deployed state and a collapsed state. More specifically, by pulling the terminal end 8 of the extendable rod 2 to provide the necessary height and rotating the second panel 6 and the third panel 7 to a deployed state, the present invention may be converted into a prayer barrier. Alternately, the present invention may be collapsed into a compact device by pushing down the extendable rod 2 and aligning the second panel 6 and the third panel 7 into a planar position.

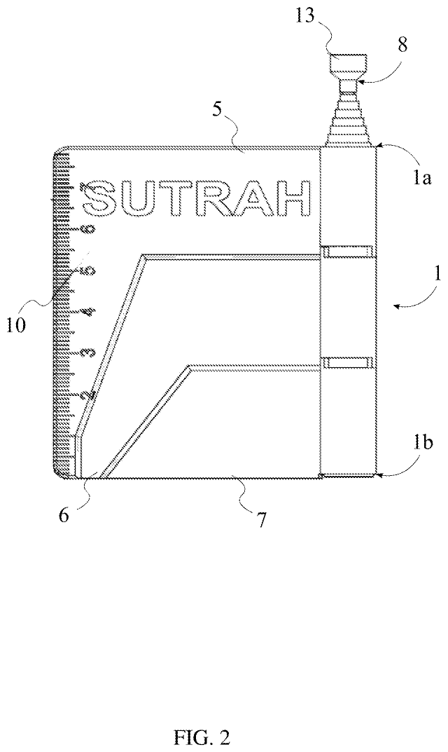

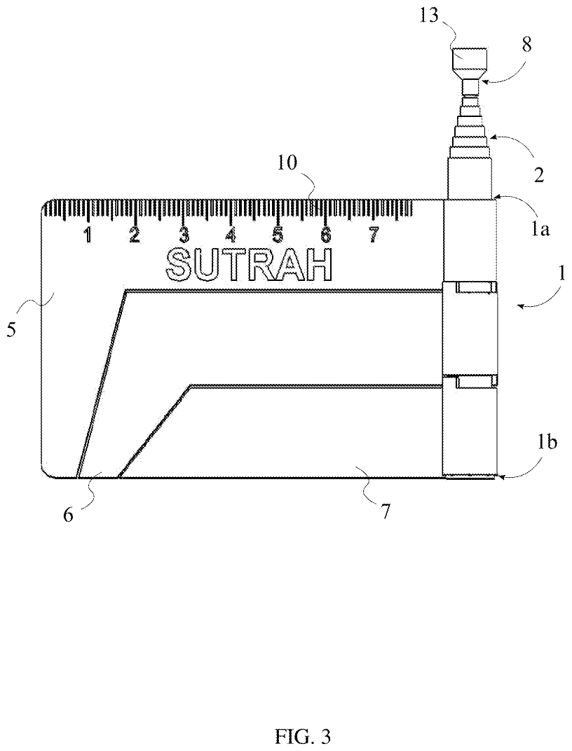

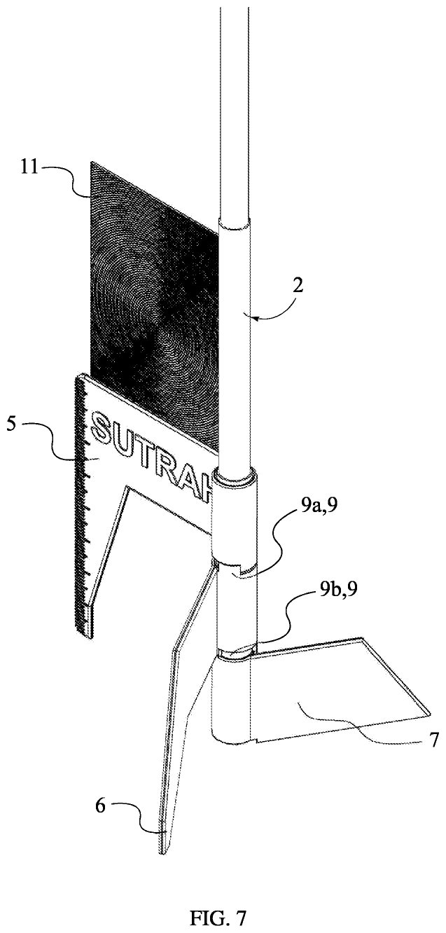

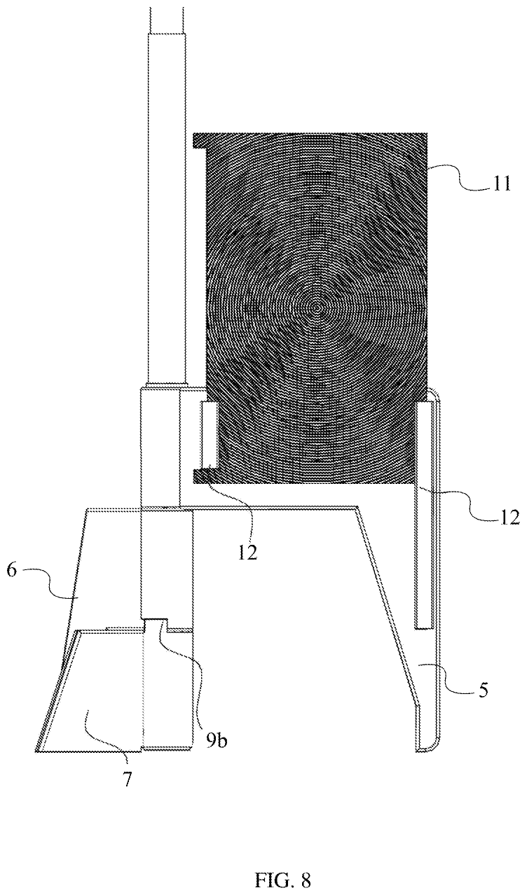

As seen in FIG. 2, FIG. 3, FIG. 7, and FIG. 8, the second panel 6 is mounted between the first panel 5 and the third panel 7. Further, the first panel 5 is stationarily fixed onto the tripod stand 3. This is because, according to the preferred embodiment, the first panel 5 forms an alignment reference and a grounding base for the present invention. To that end, as seen in FIG. 2 and FIG. 3, the first panel 5 extends from a first end 1a of the tripod 1 towards a second end 1b of the tripod 1, wherein the first end 1a is positioned opposite to the second end 1b across the tripod 1.

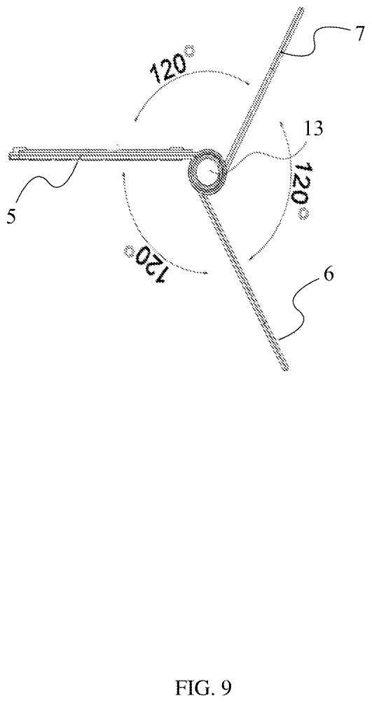

In reference to FIG. 1, FIG. 7, FIG. 8, and FIG. 9, wherein the device is in a deployed mode, each of the first panel 5, the second panel 6, and the third panel 7 are angularly offset from one another, and the extendable rod 2 is pulled out, wherein the terminal end 8 of the extendable rod 2 extends opposite to the first panel 5. As seen in FIG. 9, in the preferred embodiment, the first panel 5 is angularly offset from the second panel 6 by 120 degrees, the second panel 6 is angularly offset from the third panel 7 by 120 degrees, and the third panel 7 is angularly offset from the first panel 5 by 120 degrees. However, the first panel 5, second panel 6 and the third panel 7 may be angularly offset in any other angle, as long as the intents of the present invention are not altered.

In order to provide stability to the present invention in the deployed mode, the present invention comprises a plurality of alignment notches 9, wherein the plurality of alignment notches 9 are distributed along the tripod 1. As seen in FIG. 7, and FIG. 8, a first alignment notch 9a from the plurality of alignment notches 9 is mounted between the first panel 5 and the second panel 6, and a second alignment notch 9b from the plurality of alignment notches 9 is mounted between the second panel 6 and the third panel 7. In the preferred embodiment, the plurality of alignment notches 9 aligns each of the first panel 5, the second panel 6 and the third panel 7 securely in a locked position at 120 degrees apart, during the deployed mode. In other words, the credit card sized tripod 1 in deployed mode, make an auto 120 degrees angle between the tripod's legs, so as to maintain an even load from the main body of device. Further, the plurality of alignment notches 9 comprises wedges and grooves that lock in a particular position. However, the plurality of alignment notches 9 may comprise any other locking mechanism or technology that are known to one of ordinary skill in the art, as long as the intents of the present invention are not altered.

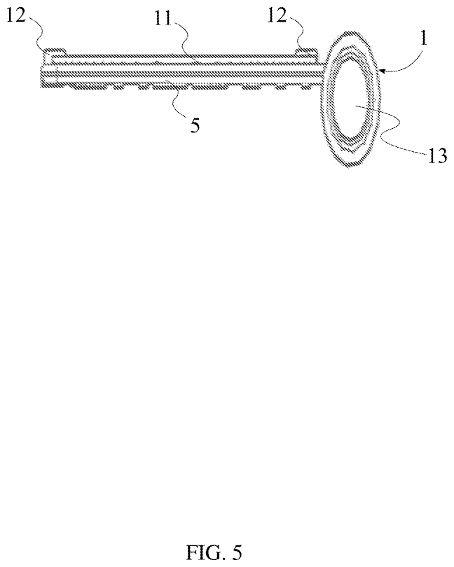

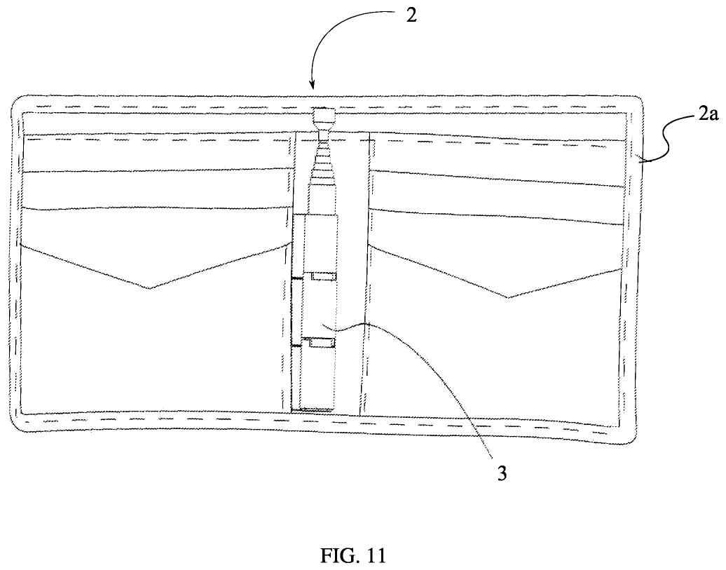

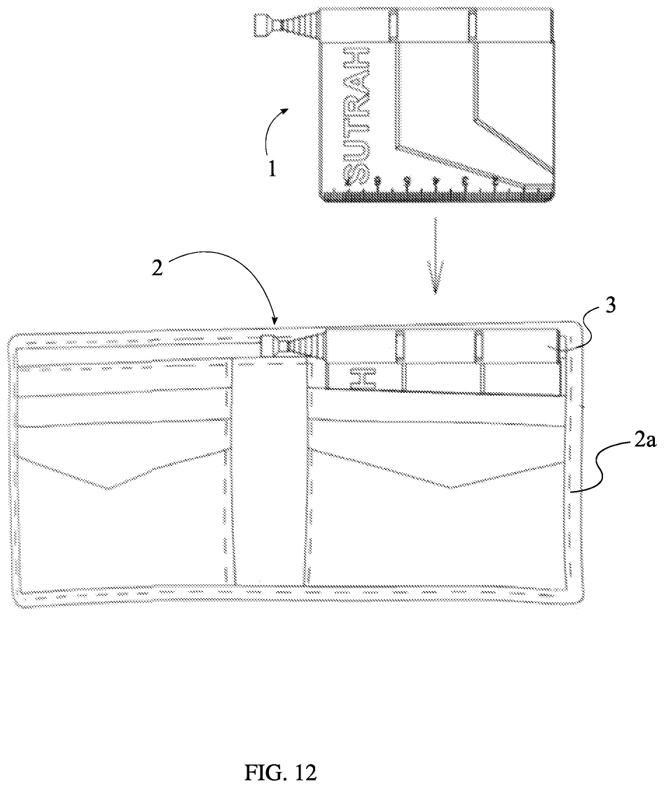

According to the preferred embodiment, the present invention is of the size of a credit card and fits in a wallet or small bag, such that it will be easy for a user to carry the present invention without any extra space or effort. To that end, and in reference to FIG. 2, FIG. 3, FIG. 5, and FIG. 10 through FIG. 12, wherein the device is in a collapsed mode, the second panel 6 and the third panel 7 are aligned parallel to the first panel 5. Further, the extendable rod 2 is retracted, and the terminal end 8 of the extendable rod 2 is positioned adjacent the first panel 5. Thus, as seen in FIG. 11 and FIG. 12 the tripod 1 and the extendable rod 2 together fit within a wallet 2a, making the present invention compact and user friendly. In reference to FIG. 11, the present invention is placed horizontally within a side pocket of the wallet 2a, and in reference to FIG. 12, the present invention is pushed down into a vertical pocket, panel side down, into the wallet 2a.

It is an aim of the present invention to be beneficial for both muslims and non-muslims by its properties and multifunctionalities. To that end, the present invention comprises a ruler 10, wherein the ruler 10 is integrated into the first panel 5. As seen in FIG. 2 and FIG. 3, a small ruler in metric unit is engraved onto a longer side of the first panel 5. However, the ruler may be of any unit and may be positioned in any other location, as long as the intents of the present invention are fulfilled. Accordingly, in reference to FIG. 2, the ruler 10 is integrated/engraved onto a vertical edge of the first panel 5. In reference to FIG. 3, the ruler 10 is engraved onto a horizontal edge of the first panel 5.

Continuing with the preferred embodiment, the present invention comprises a magnifying device 11 and at least one groove 12. As seen in FIG. 7 and FIG. 8, the at least one groove 12 is mounted onto terminal edges of the first panel 5 and the magnifying device 11 is slidably engaged within the at least one groove 12. Preferably, the magnifying device 11 is a fire starter lens or tool, such as a thin Fresnel lens, such that the magnifying device 11 may benefit people with vision problems or be provided as a fire starter in a survival kit. However, the magnifying device 11 may comprise any other lens and/or technology, and maybe integrated into any other location, as long as the objectives of the present invention are not hindered.

According to the preferred embodiment, the present invention further comprises a pick-up tool 13, wherein the pick-up tool 13 is mounted on to the terminal end 8 of the extendable rod 2. Preferably, the pick-up tool 13 is magnetic, and comprises a strong Neodymium magnet attached on top of the extendable telescopic main body of the sutrah, as a magnetic pickup tool and as a removable extra sign fastener. However, the pick-up tool 13 may comprise any other pick-up device or fastening device that are known to one of ordinary skill in the art, as long as the intents of the present invention are not altered.

In order to make the present invention/sutrah more noticeable by other people from a distance, the present invention comprises a removable sign 14, wherein the removable sign 14 is detachably attached adjacent the terminal end 8 of the extendable rod 2. As seen in FIG. 1 and FIG. 10, the removable sign is a flag, that is removably attached to the magnetic pick-up tool 13 at the end of the extendable rod 2. However, the removable sign 14 may comprise any other size, shape, and attachment means, as long as the intents of the present invention are not altered.

Although the invention has been explained in relation to its preferred embodiment, it is to be understood that many other possible modifications and variations can be made without departing from the spirit and scope of the invention as hereinafter claimed.

What is claimed is:

1. A multifunctional praying barrier device, the device comprising:
a tripod;
an extendable rod;
the tripod comprising a tripod stand, a canal, a first panel, a second panel, and a third panel;
the canal traversing normally and centrally through the tripod stand;
the extendable rod being mounted within the canal;
the second panel and the third panel being rotatably mounted around the extendable rod; and
the tripod being operatively coupled to the extendable rod, wherein manipulating the second panel, the third panel, and a terminal end of the extendable rod, enables switching the device between a collapsed mode and a deployed mode.

2. The multifunctional praying barrier device of claim 1, wherein:
the second panel being mounted between the first panel and the third panel; and
the first panel being stationarily fixed onto the tripod stand.

3. The multifunctional praying barrier device of claim 1, comprising:
the first panel extending from a first end of the tripod towards a second end of the tripod, wherein the first end being positioned opposite to the second end across the tripod.

4. The multifunctional praying barrier device of claim 1, comprising:
wherein the device is in a deployed mode:
each of the first panel, the second panel, and the third panel being angularly offset from one another; and
the extendable rod being pulled out and the terminal end of the extendable rod extending opposite to the first panel.

5. The multifunctional praying barrier device of claim 4, comprising:
the first panel being angularly offset from the second panel by 120 degrees;
the second panel being angularly offset from the third panel by 120 degrees; and
the third panel being angularly offset from the first panel by 120 degrees.

6. The multifunctional praying barrier device of claim 1, comprising:
wherein the device is in a collapsed mode:
the second panel and the third panel being aligned parallel to the first panel;
the extendable rod being retracted; and
the terminal end of the extendable rod being positioned adjacent the first panel.

7. The multifunctional praying barrier device of claim 6, wherein the tripod and the extendable rod together fit within a wallet.

8. The multifunctional praying barrier device of claim 1, comprising:
a plurality of alignment notches;
the plurality of alignment notches being distributed along the tripod.

9. The multifunctional praying barrier device of claim 8, comprising:
a first alignment notch from the plurality of alignment notches being mounted between the first panel and the second panel;
a second alignment notch from the plurality of alignment notches being mounted between the second panel and the third panel.

10. The multifunctional praying barrier device of claim 1, comprising:
a ruler;
the ruler being integrated into the first panel.

11. The multifunctional praying barrier device of claim 1, comprising:
a magnifying device;
at least one groove;
the at least one groove being mounted onto terminal edges of the first panel; and
the magnifying device being slidably engaged within the at least one groove.

12. The multifunctional praying barrier device of claim 11, wherein the magnifying device being a fire starter lens.

13. The multifunctional praying barrier device of claim 1, comprising:
a pick-up tool;
the pick-up tool being mounted on to the terminal end of the extendable rod.

14. The multifunctional praying barrier device of claim 1, comprising:
a removable sign;
the removable sign being detachably attached adjacent the terminal end of the extendable rod.

15. The multifunctional praying barrier device of claim 14, wherein the removable sign being a flag.

16. A multifunctional praying barrier device, the device comprising:
a tripod;
an extendable rod;
the tripod comprising a tripod stand, a canal, a first panel, a second panel, and a third panel;
the first panel being stationarily fixed onto the tripod stand.
the second panel being mounted between the first panel and the third panel;
the canal traversing normally and centrally through the tripod stand;
the extendable rod being mounted within the canal;
the second panel and the third panel being rotatably mounted around the extendable rod; and
the tripod being operatively coupled to the extendable rod, wherein manipulating the second panel, the third panel, and a terminal end of the extendable rod, enables deployment and collapsing of the device.

17. The multifunctional praying barrier device of claim 16, comprising:
wherein the device is in a deployed mode:
each of the first panel, the second panel, and the third panel being angularly offset from one another; and
the extendable rod being pulled out and the terminal end of the extendable rod extending opposite to the first panel.

18. The multifunctional praying barrier device of claim 1, comprising:
wherein the device is in a collapsed mode:
the second panel and the third panel being aligned parallel to the first panel;
the extendable rod being retracted; and
the terminal end of the extendable rod being positioned adjacent the first panel.

19. The multifunctional praying barrier device of claim 1, comprising:
a ruler;
a pick-up tool;
a removable sign;
the ruler being integrated into the first panel;
the pick-up tool being mounted on to the terminal end of the extendable rod;
the removable sign being detachably attached adjacent the terminal end of the extendable rod.

20. The multifunctional praying barrier device of claim 16, comprising:
a magnifying device;
at least one groove;
the at least one groove being mounted onto terminal edges of the first panel; and
the magnifying device being slidably engaged within the at least one groove.
